(19) United States
(12) Patent Application Publication
(10) Pub. No.: US 2014/0172130 A1
(43) Pub. Date: Jun. 19, 2014

(54) Modular System And Associated Method

(71) Applicant: Control Techniques Limited, Newtown (GB)

(72) Inventor: Richard Mark Wain, Newtown (GB)

(73) Assignee: Control Techniques Limited, Newtown (GB)

(21) Appl. No.: 14/108,720

(22) Filed: Dec. 17, 2013

(30) Foreign Application Priority Data
Dec. 19, 2012 (GB) 1222931.6

(51) Int. Cl. G05B 19/042

(52) U.S. Cl. CPC G05B 19/0426
USPC 700/86

(57) ABSTRACT

A method for setting-up a module of a modular industrial control system so that the module is easily integrated into the modular system is disclosed along with a method for setting-up a modular industrial control system for connecting a new module to the modular industrial control system, a module for forming part of a modular industrial control system comprising a plurality of modules and a controller for controlling the plurality of modules, a modular industrial control system, and a corresponding computer readable medium. The method for setting-up a module of a modular industrial control system so that the module is easily integrated into the modular system comprises programming a module for use in a modular industrial control system with a name corresponding to the name used by a control code of a controller of the modular industrial control system to control the module.

### CROSS-REFERENCE TO RELATED APPLICATION

This application claims the benefit and priority of Great Britain Patent Application No. 1222931.6 filed Dec. 19, 2012. The entire disclosure of the above application is incorporated herein by reference.

### FIELD

This disclosure relates to a modular system in which industrial control modules of the system can be easily replaced. More specifically, but not exclusively, a system and corresponding method for control of such a system is provided, the system comprising a controller for controlling a plurality of industrial control modules that is able to recognise the modules of the system.

### BACKGROUND

Modular electronic, electrical and electro-mechanical systems are commonly used in many industries. In such systems, a controller is used to control the plurality of modules in the system to provide one or more desired functions.

An example of such a system is shown in FIG. 1, which illustrates a prior art system 100 for driving a milling machine. In particular, the system 100 comprises three drive modules, a first drive module 101 for driving an x-axis of the milling machine, a second drive module 102 for driving a y-axis of the milling machine, and a third drive module 103 for driving a z-axis of the milling machine. Each of the three modules is then driven by a controller 110 in accordance with control code 111 stored within memory of the controller. In this example, all of the modules 101, 102, 103 are identical apart from what other devices they are connected to and therefore what it is that they drive.

Such modular systems are advantageous for various reasons. For example, utilising a modular system means that a standard controller can be utilised for controlling different systems and simply programmed to perform the required functionality for the system in question. Furthermore, standard modular components can be utilised where possible, and each module can be replaced if faulty rather than having to attempt fix or even replace the whole system. Hence, such systems are advantageous because they are relatively cheap and easy to both manufacture and maintain.

The code 111 used by the controller to perform the control functionality includes the routine shown below:

ABSMove(Axis :=‘X_Axis’, Position :=10);

AxisVelocity(Axis :=‘Y_Axis’, Velocity :=20);

RELMove(Axis :=‘Z_Axis’, RelPosition:=30);

When implementing the code 111 the controller firstly executes the first line of the code: ABSMove(Axis :=‘X_Axis’, Position :=10). This firstly involves determining which module drives the x-axis. The controller 110 does this by using a look-up table 112 stored in the memory associated with the controller 110. For example, the controller will ask the look-up table which module corresponds to the X_Axis and the look-up table will then return information indicating that module with serial number 123 corresponds to the X_Axis. Consequently, the controller 110 will instruct the module having serial number 123 to move to Position 10.

FIGS. 2 and 3 show the circumstances wherein a module is faulty and has to be replaced. In particular, module 102 is faulty and is therefore replaced by module 104. However, as can be seen in FIG. 2, look-up table 112 specifies that the Y_Axis is driven by the module having serial number 456. Since the module has now been changed, as can be seen from FIG. 3, the look-up table has to be updated to specify that the module with serial number 246 corresponds to the Y_Axis. However, updating the look-up table 112 of the controller 110 requires a maintenance engineer to actively update the look-up table. This can involve opening the control software in a development suite on a PC, identifying which table or software module of there will almost always be very many, even in a modest system, requires modifying. Working out the required change, modifying the table, re-compiling if required and then downloading the update to the controller. All of this has an element of risk: e.g. the wrong table could be modified, unintended modifications could be made, the complier may be a different revision and the code may behave differently to intended. This process therefore takes additional time for the maintenance engineer, which in turn costs money for the maintenance engineer to reconfigure the system to operate with the new module, which is identical to the previous module except that it has a new serial number that needs to be programmed into the look-up table.

### SUMMARY

Embodiments of the present invention attempt to mitigate at least some of the above-mentioned problems.

In accordance with an aspect of the invention there is provided a method for setting-up a module of a modular industrial control system so that the module is easily integrated into the modular system. The method comprises programming a module for use in a modular industrial control system with a name corresponding to the name used by a control code of a controller of the modular industrial control system to control the module. The name programmed into the module may be identical to the name used by the control code. The name may be programmed into a memory of the module.

In accordance with another aspect of the invention there is provided a method for setting-up a modular industrial control system for connecting a new module to the modular industrial control system. The method comprises interrogating one or more modules of a modular industrial control system in order to determine a name associated with the interrogated one or more modules. The method also comprises comparing the name of the one or modules with one or more names of modules referred to in a control code used for controlling the one or more modules. The interrogation process may comprise interrogating all modules of the modular industrial control system. The method may further comprise a step of obtaining the module names referred to in the control code prior to performing the step of comparing. The method may also further comprise implementing the control code if modules having names corresponding to all of the modules referred to in the control code are identified. Furthermore, the method may further comprise producing a signal indicating that a maintenance engineer is required if modules having names corresponding to all of the modules referred to in the control code are not identified. The method may be performed by a controller of the modular industrial control system.

In accordance with yet another aspect of the invention a module for forming part of a modular industrial control system is provided that comprises a plurality of modules and a controller for controlling the plurality of modules. The module may comprise a memory having a name stored thereon, the name corresponding to a name used by a control code of a controller of a modular industrial control system for which the module is arranged for use within to control the module.

In accordance with a further aspect of the invention a modular industrial control system is provided. The system comprises a plurality of modules and a controller for controlling the plurality of modules. Each module may have a name programmed in its internal memory, each name corresponding to a name used by the controller to instruct the respective module.

The controller may comprise a memory arranged to store code and a processor arranged to implement the code, wherein the code provides a process for instructing the modules. One of the plurality of modules may be a module as disclosed herein.

In accordance with another aspect of the invention there is provided a computer readable medium comprising computer readable code operable, in use, to instruct a computer to perform a method as described herein.

Embodiments of the invention provide an identification module within a system with a name store in the module itself.

The system of embodiments of the invention aides the maintenance of the system when a module or modules within the system fail. The system may consist of modules connected via a common communication network.

In embodiments of the invention the controller may be checking the user given names at power up. Providing the name has been programmed into a replacement module prior to the installation of the replacement module, the controller will recognise the function of the new module within the system and “know” which instructions apply to that module.

An advantage of embodiments of the invention is that the only skill required at the system's location is the ability to physically install the replacement module; no software skills are required at the location provided the name was programmed into the new module before delivery, e.g. at the system manufacturer's supply hub.

Advantageously, embodiments of the invention provide a system that utilises less processing power and less memory when operating because a look-up table need not be stored in memory and the process does not need to run the additional processing to perform the look-up operation.

### BRIEF DESCRIPTION OF THE DRAWINGS

Exemplary embodiments of the invention shall now be described with reference to the drawings in which:

FIG. 1 illustrates a prior art modular system for controlling three drive modules;

FIG. 2 illustrates the prior art modular system of FIG. 1 when a module of the modular system is being replaced;

FIG. 3 illustrates the prior art modular system of FIG. 2 after the module has been replaced;

FIG. 4 illustrates a modular drive system for controlling three drive modules according to an embodiment of the invention;

FIG. 5 illustrates the modular drive system of FIG. 4 when a module of the modular system is being replaced;

FIG. 6 illustrates the modular drive system of FIG. 5 after the module has been replaced; and

FIG. 7 illustrates a process used by a controller of the modular system for recognising the installation of a new module.

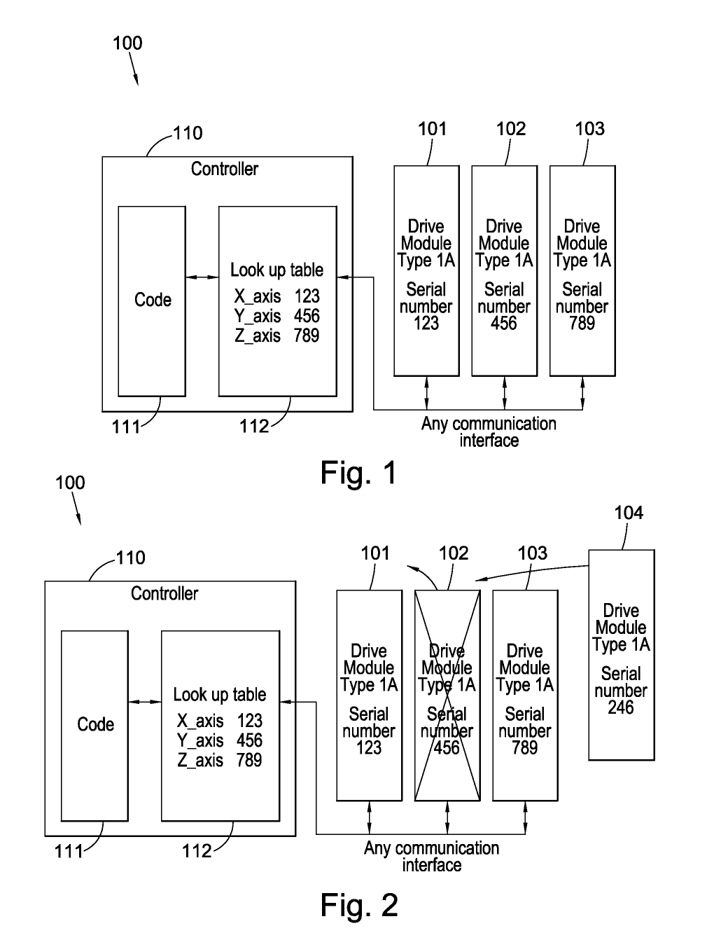

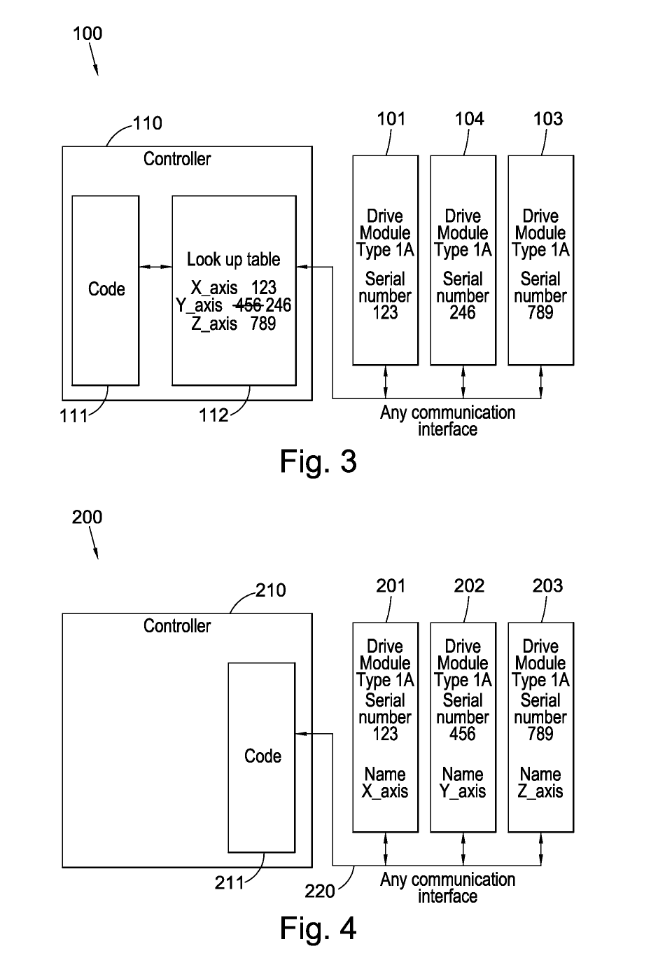

Throughout the description and the drawings, like reference numerals refer to like parts.

### DETAILED DESCRIPTION

FIG. 4 shows a modular system 200. The modular system is arranged to allow for a simple maintenance procedure to be implemented when one or more of the modules has to be replaced.

The system 200 comprises a number of modules 201, 202, 203 each controlled by a controller 210 via a communications interface 220. The controller 210 comprises a processor (not shown) and a memory (not shown). The memory is arranged to store Code 211 for performing a procedure for controlling the operation of the associated modules 201, 202, 203, while the processor is arranged to execute the code in order to perform the procedure.

The first module 201, second module 202, and third module 203 are each drive modules for driving an x, y, and z axis of a milling machine, respectively. As can be seen from FIG. 4, each module is the same type of module, e.g. a Type 1A drive module. Each module has an associated serial number. Furthermore, each module has a respective name, e.g. X_Axis, Y_Axis, Z_Axis, pre-programmed into its memory. This pre-programming takes place at a manufacturing or supply hub of the device manufacturer. The programmed name corresponds to the name used by the controller to instruct the module. Hence, by programming the name of the module into a non-volatile memory of the module, once each module is installed into the system including the controller 210, the controller will automatically recognise and be able to send direct instructions to each of the modules 201, 202, 203.

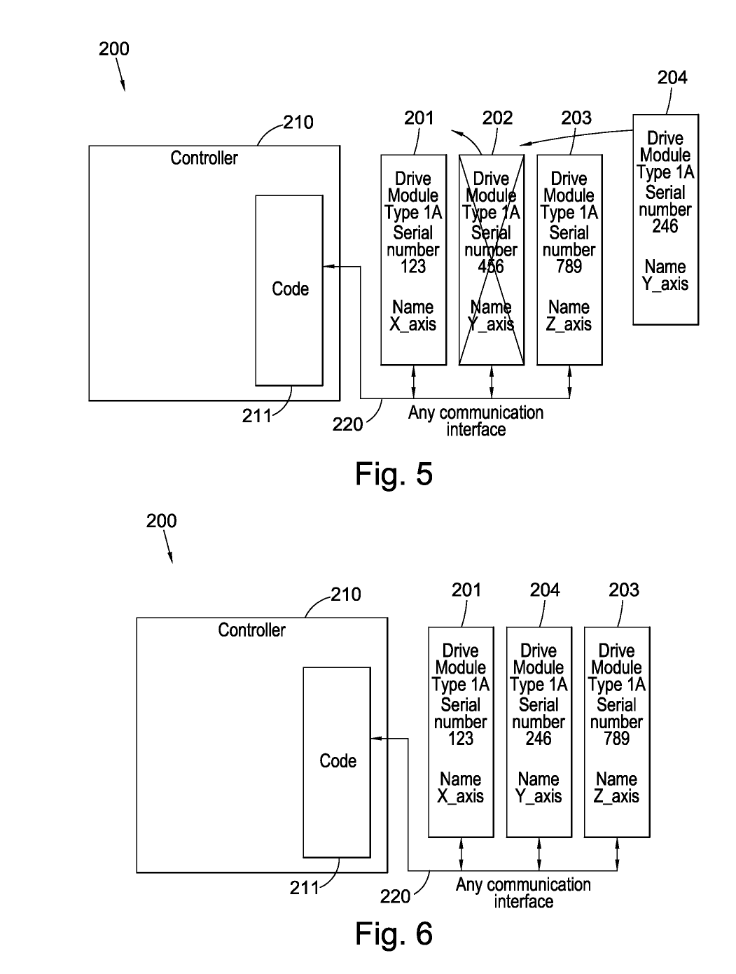

FIG. 5 shows an instance in which one of the modules 202 becomes faulty and has to be removed. Consequently, module 202 is replaced by equivalent replacement module 204. While each of modules 202 and 204 have different serial numbers, they have both been programmed to specify that their name is ‘Y_Axis’ Consequently, as soon as the module 204 is installed, as shown in FIG. 6, the module 204 is operational within the system because the controller recognises the new module. No programming of the system is required upon installation of a new module. All of the system programming is carried out at the manufacturing plant. Consequently, the cost of maintenance is heavily reduced because maintenance engineers only require the skills to remove an old module and connect a new module; no computer programming skills are required. Furthermore, the time taken for an engineer to replace a module is dramatically reduced thereby reducing overall maintenance engineer labour costs.

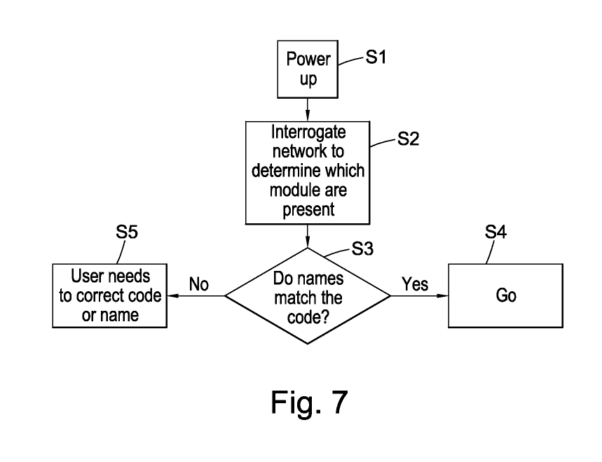

FIG. 7 shows a process used by the controller for recognising the installation of a new module. When an engineer replaces a module, the engineer firstly turns off the power to the system 200. The engineer then replaces the old module 202 with the new module 204. The power is then turned back on, as shown by step S1. The controller 210 then interrogates the network to determine which modules and their names in the system 200 are connected to the communications link 220. In the system 200 the controller obtains the names X_Axis, Y_Axis, and Z_Axis as shown in step S2. The controller then compares the obtained names to the names required by the code, step S3. The code used in the system 200 is set-out below:

ABSMove(Axis :=‘X_Axis’, Position :=10);

AxisVelocity(Axis :=‘Y_Axis’, Velocity :=20);

RELMove(Axis :=‘Z_Axis’, RelPosition:=30);

The controller 210 then recognises that all of the modules referred to in the code, i.e. X_Axis, Y_Axis, and Z_Axis, are present in the system 200. Consequently, the controller is then able to perform the control procedure at step S4.

If the controller determines that there are modules referred to in the code 211 that are not connected to the system 200 then the method proceeds to step S5. At step S5, either the code will need to be corrected to refer to the correct module name, the module will need to be programmed with the correct name, or the correct module will need to be installed.

It will be appreciated that embodiments of the invention are applicable to any system comprising a number of modules to be replaced. The specific functionality of modules of the system is not relevant to embodiments of the invention. While the modules are all shown as having the same functionality in the embodiment described above, it will be appreciated that the system may include a plurality of modules with different functionalities.

When implemented by a processor by a computer program on any type of computer, a computer would be provided having a memory to store the computer program, and a processor to implement the computer program. The processor would then perform the algorithmic process. The computer program may include computer code arranged to instruct a computer to perform the functions of one or more of the various methods described above. The computer program and/or the code for performing such methods may be provided to an apparatus, such as a computer, on a computer readable medium. The computer readable medium could be, for example, an electronic, magnetic, optical, electromagnetic, infrared, or semiconductor system, or a propagation medium for data transmission, for example for downloading the code over the Internet. Non-limiting examples of a physical computer readable medium include semiconductor or solid state memory, magnetic tape, a removable computer diskette, a random access memory (RAM), a read-only memory (ROM), a rigid magnetic disc, and an optical disk, such as a CD-ROM, CD-R/W or DVD.

1. A method for setting-up a module of a modular industrial control system so that the module is easily integrated into the modular system, the method comprising:
programming a module for use in a modular industrial control system with a name corresponding to the name used by a control code of a controller of the modular industrial control system to control the module.

2. The method according to claim 1, wherein the name programmed into the module is identical to the name used by the control code.

3. The method according to claim 1, wherein the name is programmed into a memory of the module.

4. A method for setting-up a modular industrial control system for connecting a new module to the modular industrial control system, the method comprising:
interrogating one or more modules of a modular industrial control system in order to determine a name associated with the interrogated one or more modules; and
comparing the name of the one or modules with one or more names of modules referred to in a control code used for controlling the one or more modules.

5. The method according to claim 4, wherein the interrogation process comprises interrogating all modules of the modular industrial control system.

6. The method according to claim 4, further comprising a step of obtaining the module names referred to in the control code prior to performing the step of comparing.

7. The method according to claim 4, further comprising implementing the control code if modules having names corresponding to all of the modules referred to in the control code are identified.

8. The method according to claim 4, further comprising producing a signal indicating that a maintenance engineer is required if modules having names corresponding to all of the modules referred to in the control code are not identified.

9. The method according to claim 4, wherein the method is performed by a controller of the modular industrial control system.

10. A module for forming part of a modular industrial control system comprising a plurality of modules and a controller for controlling the plurality of modules, the module comprising:
a memory having a name stored thereon, the name corresponding to a name used by a control code of a controller of a modular industrial control system for which the module is arranged for use within to control the module.

11. A modular industrial control system, comprising:
a plurality of modules; and
a controller for controlling the plurality of modules, wherein
each module has a name programmed in its internal memory, each name corresponding to a name used by the controller to instruct the respective module.

12. The modular industrial control system according to claim 11, wherein the controller comprises:
a memory arranged to store code; and
a processor arranged to implement the code, wherein the code provides a process for instructing the modules.

13. The modular industrial control system according to claim 11, wherein one of the plurality of modules is a module for forming part of a modular industrial control system comprising a plurality of modules and a controller for controlling the plurality of modules, the module comprising a memory having a name stored thereon, the name corresponding to a name used by a control code of a controller of a modular industrial control system for which the module is arranged for use within to control the module.

14. A computer readable medium comprising computer readable code operable, in use, to instruct a computer to perform the method of claim 1.
